(19) United States
(12) Patent Application Publication
(10) Pub. No.: US 2006/0133764 A1
(43) Pub. Date: Jun. 22, 2006

(54) Processing head for formation of mirror plane of optical waveguide sheet, processing apparatus, and method of forming mirror plane of optical waveguide

(75) Inventors: Akihiko Okubora, Kanagawa (JP); Hirokazu Nakayama, Kanagawa (JP)

Correspondence Address: ROBERT J. DEPKE;LEWIS T. STEADMAN, TREXLER, BUSHNELL, GLANGLORGI, BLACKSTONE & MARR, 105 WEST ADAMS STREET, SUITE 3600, CHICAGO, IL, 60603-6299, US

(73) Assignee: Sony Corporation

(21) Appl. No.: 11/281,005

(22) Filed: Nov. 17, 2005

(30) Foreign Application Priority Data
Dec. 20, 2004 (JP) P2004-367759

(51) Int. Cl. G02B 6/00

(52) U.S. Cl. 385/147; 385/31; 385/129

(57) ABSTRACT

An optoelectric device able to easily maintain a flexibility of a design so as to manage a design change and able to manage a production of a small amount and numerous varieties of products, and a method for the same, in which a processing head is provided at a top of a capillary unit, and a tip portion of the processing head has a first and a second planes crossing a symmetry axis of the processing head at an angle of 45° and crossing perpendicularly each other. The processing head is driven into an optical waveguide sheet in which an optical waveguide having a cladding and a core buried into the cladding is formed, at a position to be an end portion of the optical waveguide, so a shape of the first and the second planes is transferred at the end portion to form a mirror plane.

### CROSS REFERENCES TO RELATED APPLICATIONS

The present invention contains subject matter related to Japanese Patent Application No. JP 2004-367759 filed in the Japanese Patent Office on Dec. 20, 2004, the entire contents of which being incorporated herein by reference.

### BACKGROUND OF THE INVENTION

1. Field of the Invention

The present invention relates to a processing head for a formation of a mirror plane of an optical waveguide, a processing apparatus provided with the same, and a method of forming a mirror plane of an optical waveguide used with the same, specifically, to a processing head for a formation of a mirror plane of an optical waveguide optically coupling a semiconductor chip including a light emitting portion for emitting an optical signal and a semiconductor chip including a light receiving portion for receiving the optical signal, a processing apparatus provided with the same, and a method of forming a mirror plane of an optical waveguide used with the same.

2. Description of the Related Art

Recently, there is known that a technology concerning a semiconductor has been obviously improved and, for example, a clock frequency has exceeded GHz-order in a large scale integration (LSI) field such as a central processing unit (CPU) and a high speed logic.

In recent year, there has been populated a processing of a super high definition image data such as 4000×2000 pixels, and an improvement of a camera capturing the image data at high speed frame rate or a display reproducing the image data. There is demanded to transfer the image data without processing, between various apparatuses.

For example, in the case of 4000×2000 pixels, 240 frames, and 10 bits of three colors, a data rate becomes 57.6 Gbps, which is extremely large.

An interconnection for a signal exceeding GHz-order, whether or not it is inside or outside the LSI or inter-system, suffers from disadvantages that are not paid attention in related art. To overcome the disadvantages is an important factor for improving a performance, integrating a semiconductor device, or making higher speed in the semiconductor device. As the above disadvantages, it is mentioned that a signal integrity, a frequency limit of an electric interconnection, an interconnection loss, a delay of the interconnection, a radiation from the interconnection, a skew of a signal, and an increase of power consumption concerning an interconnection drive.

In order to overcome the above disadvantages, there are methods that an optical interconnection is used instead of the electric interconnection made of metal such as Al and Cu.

As one of the above methods, for example, it has been experimented that a method of using an optical waveguide to a connection in a board or between boards to transfer a signal by light.

Specifically, recently, since it has suffered from a disadvantage of a skew of a clock supplied to an intra-LSI chip or different LSIs, there have been improved with methods that a complete equal length interconnection is used on the board or the LSI to divide the clock signal into an optical interconnection having an approximately H-shape, so-called H-bar, to thereby suppress the skew of the interconnection.

In an optical interconnection structure unit used with the optical waveguide as described above, generally, it is demanded to convert an optical signal to an electric signal or the electric signal to the optical signal. In terms of a simplification of an assembly processing, an productivity of the interconnection, or a production cost, a light emitting device is used with a vertical cavity surface emitting laser (VCSEL) and a light receiving device is used with a PIN-PD or other plate type device, and the both devices are mounted on the LSI or the board so as to oppose a light receiving plane to a light emitting plane horizontally.

In a configuration having the above optical interconnection, it is necessary that the light emitting device or the light receiving device is optically and efficiently coupled with the optical waveguide. Generally, an end portion of the optical waveguide is processed to form a mirror plane having an angle of 45° to a light guiding direction, and the mirror plane reflects light to bend a propagating direction of the light at 90°.

As a method of forming the mirror plane, for example, there is a popular method that a blade of a dicer for cutting a semiconductor chip is polished to make 90° and used.

First, as shown in FIG. 1A and FIG. 1B corresponding to a side view of FIG. 1A, a dummy substrate 150 is formed on its surface with a release layer 151, and the release layer 151 is formed on its surface with an optical waveguide sheet 130 formed from a cladding 130a having a first refractive index and cores 130b having a pattern long in a light guiding direction in the cladding 130a and having a second refractive index higher than the first refractive index.

In a portion to be an end surface of the optical waveguide having the above structure, by using the dicer in which the blade edge is polished at 90° described above, the cores and the cladding covering the cores are cut completely or from its surface to a depth of the cores.

As a result of the cut by the dicer, as shown in FIG. 1C, a V-shaped groove V is formed in the optical waveguide sheet 130 formed from the cladding 130a and the cores 130b. A wall surface of the V-shaped groove V is the mirror plane MR.

By the above method, it is obtained with the mirror plane of 45° of relatively high reflectance, however, accuracy in a longitudinal direction depends on a positional precision of the dicer, so the accuracy is not good. Further, it is preferably for forming a plurality of the mirror planes of the optical waveguide in which end portions to be the mirror planes are arranged in a line, however, it suffers from disadvantages that it may not form the mirror planes in which the portions to be the end surface are arranged in a staggered arrangement.

As other method of forming the above 45° mirror plane, there is known a method of applying a dry etching method such as reactive ion etching (RIE).

As shown in FIG. 2A, in the same way as the above, the optical waveguide sheet 130 formed from the cores 130b and the cladding 130a covering the cores is formed. On the optical waveguide sheet 130, a resist film R having a pattern in which a portion to be the end surface is exposed, is formed.

As shown in FIG. 2B, the dummy substrate 150 is tilted at 45° and performed with the dry etching method such as RIE in which a vertical processing is possible. An etching gas is emitted at a predetermined angle β (45°) to a substrate plane.

As a result, as shown in FIG. 2C, an opening portion P having an inner wall plane with a gradient to the light guiding direction of the cores 130b, is formed in the optical waveguide sheet 130 formed from the cladding 130a and the cores 130b.

In the above method, generally, it is difficult to apply an etching selectivity ratio of a substance of the resist film to that of the optical waveguide. It is difficult to obtain a high processing precision, for example, due to a recession of a mask in etching. And, in a etching treatment in which the substrate is tilted at 45°, as the substrate to be a target increases in size, it is difficult to obtain uniformity in a processing angle or an etching rate in a limited etching chamber.

### SUMMARY OF THE INVENTION

It is desirable to provide a processing head for a formation of a mirror plane of a optical waveguide sheet able to maintain a flexibility of a design so as to manage a change of the design and able to manage a production for a small amount and numerous varieties of products, a processing apparatus used with the same, and a method of forming a mirror plane of the optical waveguide sheet.

According to an embodiment of the present invention, there is provided a processing head for a formation of a mirror plane of a optical waveguide sheet, provided at a top of a capillary unit, having: a first plane and a second plane crossing a symmetry axis of the processing head at an angle of 45° and crossing perpendicularly each other at a tip portion of the processing head, wherein the processing head is driven into an optical waveguide sheet in which an optical waveguide having a cladding and a core buried into the cladding is formed in a sheet shape, at a position to be an end portion of the optical waveguide, so a shape of the first plane and the second plane is transferred at the end portion of the optical waveguide to form a mirror plane.

The processing head according to the embodiment of the present invention is provided at a top of a capillary unit. The tip portion of the processing head has a first plane and a second plane crossing a symmetry axis of the processing head at an angle of 45° and crossing perpendicularly each other. The processing head is driven into an optical waveguide sheet in which an optical waveguide having a cladding and a core buried in the cladding is formed in a sheet shape, at a portion to be a end portion of the optical waveguide. So a shape of the first plane and the second plane is transferred to the end portion of the optical waveguide to form a mirror plane.

According to an embodiment of the present invention, there is provided a processing apparatus for forming a mirror plane of an optical waveguide sheet having a processing head provided at a top of a capillary unit, wherein a tip portion of the processing head has a first plane and a second plane crossing a symmetry axis of the processing head at an angle of 45° and crossing perpendicularly each other, and the processing head is driven into an optical waveguide sheet in which an optical waveguide having a cladding and a core buried into the cladding is formed in a sheet shape, at a position to be an end portion of the optical waveguide, so a shape of the first plane and the second plane is transferred at the end portion of the optical waveguide to form a mirror plane.

The processing apparatus according to the embodiment of the present invention has a processing head provided at a top of a capillary unit. The tip portion of the processing head has a first plane and a second plane crossing a symmetry axis of the processing head at an angle of 45° and crossing perpendicularly each other. The processing head is driven into an optical waveguide sheet in which an optical waveguide having a cladding and a core buried in the cladding is formed in a sheet shape, at a portion to be an end portion of the optical waveguide. So a shape of the first plane and the second plane is transferred to the end portion of the optical waveguide to form a mirror plane.

According to an embodiment of the present invention, there is provided a method of forming a mirror plane of an optical waveguide sheet having the steps of: driving a processing head provided at a top of a capillary unit and having a first plane and a second plane crossing a symmetry axis of the processing head at an angle of 45° and crossing perpendicularly each other at the tip portion of the processing head, into an optical waveguide sheet in which an optical waveguide having a cladding and a core buried into the cladding is formed in a sheet shape, at a position to be an end portion of the optical waveguide, and releasing the processing head from the optical waveguide sheet, and transferring a shape of the first plane and the second plane at the end portion of the optical waveguide to form a mirror plane.

In the method of forming the mirror plane of the optical waveguide sheet according to the embodiment of the present invention, first, a processing head, provided at a top of a capillary unit, of which the tip portion has a first plane and a second plane crossing a symmetry axis of the processing head at an angle of 45° and crossing perpendicularly each other, is driven into an optical waveguide sheet in which an optical waveguide having a cladding and a core buried in the cladding is formed in a sheet shape, at a portion to be an end portion of the optical waveguide.

Then, the processing head is released from the optical waveguide sheet. So, a shape of the first plane and the second plane is transferred to the end portion of the optical waveguide to form a mirror plane.

According to the processing head for a formation of the mirror plane of the optical waveguide of the embodiment of the present invention, it is able to maintain a flexibility of a design so as to manage a change of the design and able to manage a production for a small amount and numerous varieties of products.

According to the processing apparatus for forming the mirror plane of the optical waveguide of the embodiment of the present invention, it is able to maintain a flexibility of a design so as to manage a change of the design and able to manage a production for a small amount and numerous varieties of products.

According to the method of forming the mirror plane of the optical waveguide of the embodiment of the present invention, it is able to maintain a flexibility of a design so as to manage a change of the design and able to manage a production for a small amount and numerous varieties of products.

### BRIEF DESCRIPTION OF THE DRAWINGS

The above and other features of embodiments of the present invention will be apparent in more detail with reference to the accompanying drawings, in which:

FIGS. 1A to 1C are schematic views of a method of forming a mirror plane of an optical waveguide sheet according to a first example in related art;

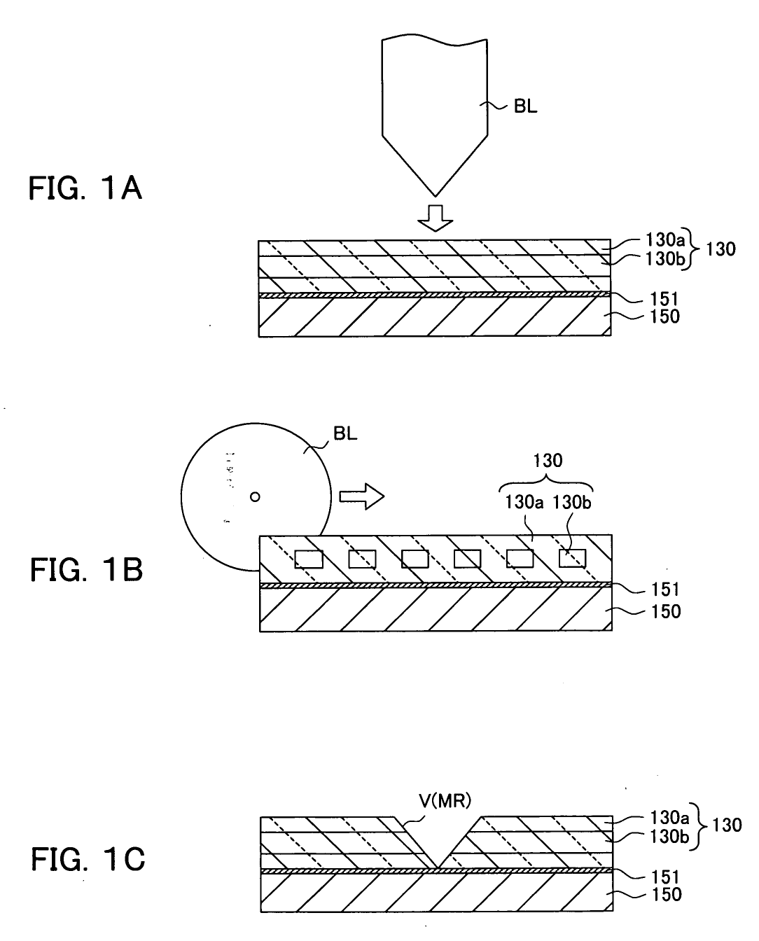

FIGS. 2A to 2C are schematic views of a method of forming the mirror plane of the optical waveguide sheet according to a second example in related art;

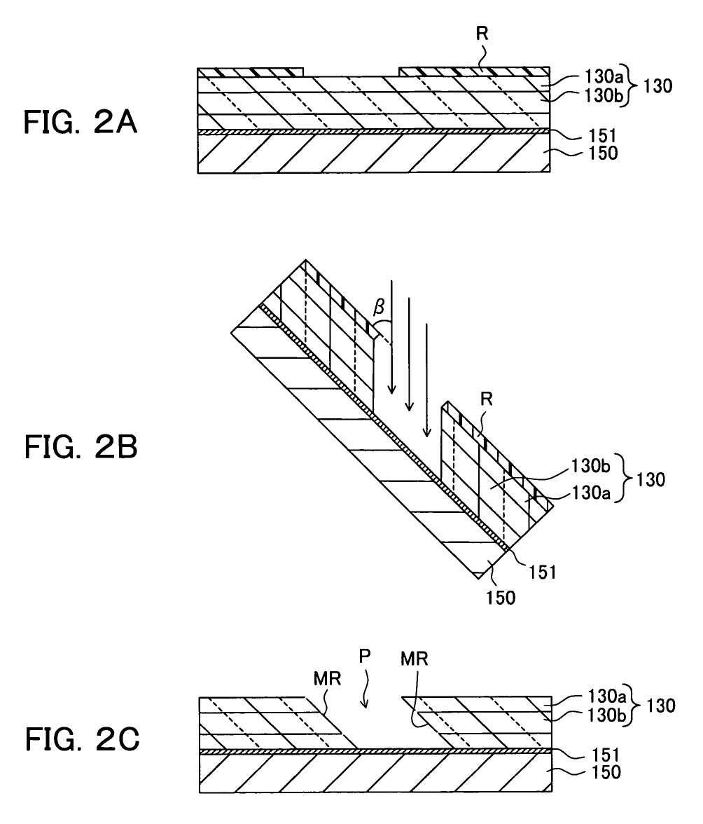

FIG. 3A is a schematic perspective view of a processing head portion of a processing apparatus provided with a processing head for forming a mirror plane of an optical waveguide sheet according to a first embodiment of the present invention, FIG. 3B is a side view of the processing head, and FIG. 3C is a side view perpendicular to FIG. 3B;

FIGS. 4A to 4D are cross-sectional views of a process of a method of forming the mirror plane of the optical waveguide sheet according to the first embodiment of the present invention;

FIG. 5 is a cross-sectional view of an optoelectric device being a multi-chip module according to a second embodiment of the present invention;

FIGS. 6A to 6C are cross-sectional views of a process of a method of producing the multi-chip module according to the second embodiment of the present invention;

FIGS. 7A to 7C are cross-sectional views of a process of a method of producing the multi-chip module according to the second embodiment of the present invention;

FIGS. 8A to 8C are cross-sectional views of a process of a method of producing the multi-chip module according to the second embodiment of the present invention; and

FIG. 9A is a cross-sectional view of a multi-chip module according to a third embodiment of the present invention, and FIG. 9B is a plan view thereof.

### DESCRIPTION OF THE PREFERRED EMBODIMENTS

Preferred embodiments of a processing head for a formation of a mirror plane of an optical waveguide sheet, a processing apparatus, and a method of forming a mirror plane of an optical waveguide sheet according to the present invention, will be described in more detail with reference to the accompanying drawings.

### First Embodiment

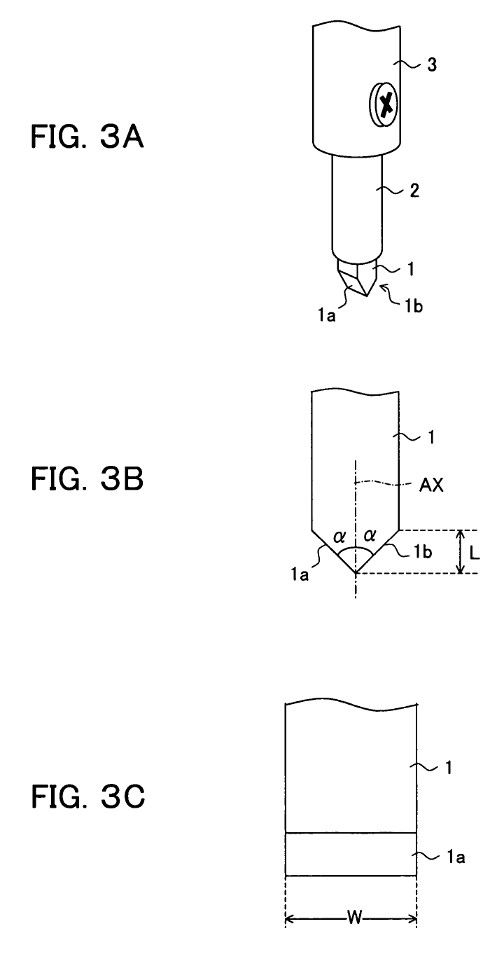

FIG. 3A is a schematic perspective view of a processing head portion of a processing apparatus provided with a processing head for forming a mirror plane of an optical waveguide sheet according the present embodiment.

A processing head 1 is provided at a top of an approximately cylinder-shaped capillary 2. An end portion of the capillary 2, opposed side to the processing head 1, is held by a capillary holding unit 3.

FIG. 3B is a side view of the processing head according to the present embodiment, and FIG. 3C is a side view perpendicular to FIG. 3B.

The tip portion of the processing unit 1 has a first plane 1a and a second plane 1b crossing a symmetry axis AX of the processing head 1 at a predetermined angle α (45°), and crossing perpendicularly each other.

The processing head has a shape such that the processing head is driven into an optical waveguide sheet in which an optical waveguide having a cladding and a core buried into the cladding is formed in a sheet shape, at a position to be an end portion of the optical waveguide, to transfer a shape of the first plane 1a and the second plane 1b at the end portion of the optical waveguide and to thereby form a mirror plane.

The processing head according to the present embodiment is preferably provided with a heat unit (means) for heating the processing head.

In processing the optical waveguide sheet, for example, in the case where the optical waveguide sheet is formed by a thermoplastic resin, the optical waveguide sheet is softened by applying heat to make the processing easy. Otherwise, for example, in the case where the optical waveguide sheet is formed by a thermosetting resin, the sheet is cure by applying heat to maintain a processed shape. In the both case, the heat temperature is less than a thermal decomposition temperature of the optical waveguide sheet resin.

The processing head 1 is preferably formed of: alumina, aluminum nitride, silicon carbide, boron nitride, or other ceramics; sapphire, ruby, diamond, or other artificial (man-made) mineral; stainless, tungsten, titan, or other metal or metal alloy; carbide of tungsten, titan, aluminum, silicon, tantalum, nitride thereof, or carbonitride thereof, so-called a super steel alloy; or the super steel alloy added with an additive such as cobalt, nickel, chrome, and molybdenum.

A length L in which the first plane 1a and the second plane 1b are projected to the symmetry axis AX, is set to be equal to or greater than a thickness to be processed of the optical waveguide sheet, processed by the processing head 1, and at least, it is set to a thickness up to a lower surface of the core, for example, a thickness of the whole optical waveguide sheet.

A width of the first plane 1a and the second plane 1b is set to be equal to or greater than a width of the optical waveguide sheet to be processed by the processing head 1.

Hereinafter, a method of forming the mirror plane of the optical waveguide sheet by using the processing head will be described.

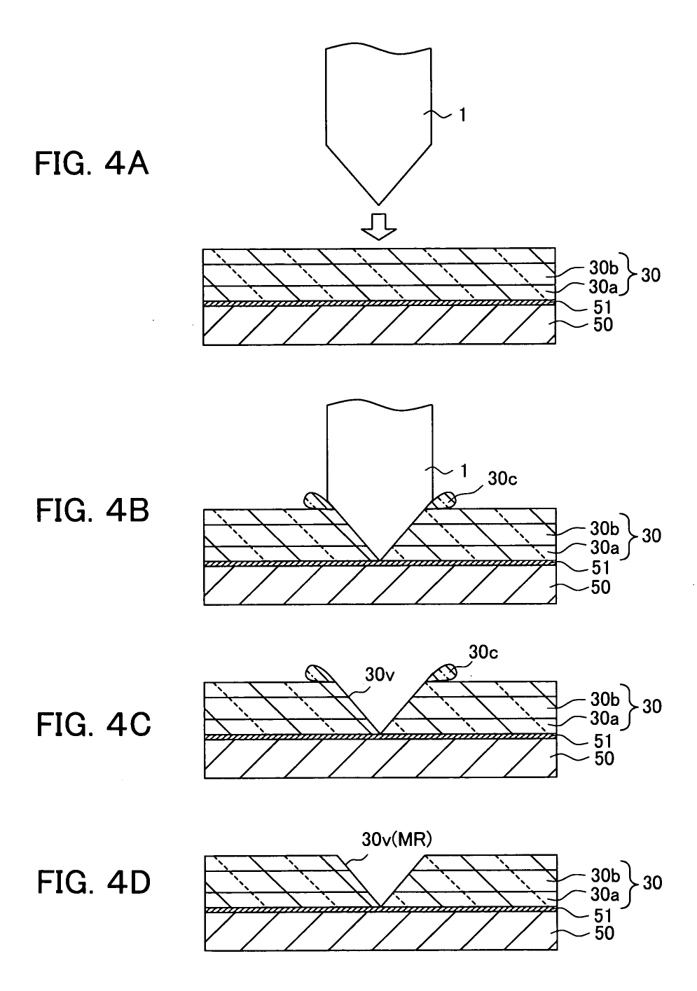

As the optical waveguide sheet to be processed, as shown in FIG. 4A, a release layer 51 is formed on a dummy substrate 50 such as silicon or glass, the optical waveguide sheet 30 is formed on them. Namely, a cladding material is coated on the release layer 51 and performed with a cure treatment, a core material is coated on the cured cladding material and performed with a pattern exposure and a development treatment to form a predetermined pattern, and the cladding material is coated over the core and flattened and cured to make a sheet shape.

As described above, it is provided with the optical waveguide sheet 30 formed in a sheet shape and having: the cladding 30a with a first refractive index; and the core 30b coated by the cladding 30a, having a strip shaped pattern long in a light guiding direction, and having a second refractive index higher than the first refractive index.

As the release layer 51, for example, a titan-copper laminated body having poor bondability with a resin material forming the optical waveguide sheet, or a silicon oxide film dissoluble to a specific acid may be used.

The optical waveguide sheet is transparent to a light wavelength to be applied, for example, it is made of an organic-based material such as polyimide resin, polyolefin resin, polynorbornene resin, acrylic resin, epoxy resin, or fluoride thereof.

Assuming a multimode propagation, it is preferable that a thickness and a width of the core 30b are approximately 5 to 50 μm, and the thickness of the cladding 30a is ¼ to ½ of the core 30b.

Then, as shown in FIG. 4B, the position to be the end portion of the optical waveguide and the processing head are positioned, and the processing head is driven into the optical waveguide sheet having the above structure by applying a predetermined power. The processing head 1 is driven up to reaching the release layer 51, which is lower layer of the optical waveguide sheet, such that the tip portion of the processing head 1 reaches at least a lower surface of the core 30b.

In the above case, a part of the material of the optical waveguide sheet may be pushed out, so a processed residue (burr) 30c may be sometimes generated from a portion processed by the processing head 1.

As shown in FIG. 4C, the processing head 1 is released from the optical waveguide sheet 30, so a shape of the first plane 1a and the second plane 1b of the processing head 1 is transferred to the end portion of the optical waveguide to form a V-shaped groove 30v. A wall surface of the V-shape groove 30v is the mirror plane MR.

A surface of the optical waveguide is directed facedown on a polishing sheet, and a lapping treatment is performed on the surface to remove the processed residue 30c as shown in FIG. 4D. The residue may be sometimes generated on the processing head, so the processing head is scrubbed by using a dummy processing substrate, if necessary, to remove the residue.

As a result, the mirror plane of the optical waveguide can be formed by using the processing head.

The step of driving the processing head at the position to be the end portion of the optical waveguide is performed, for example, while the optical waveguide sheet is held at a predetermined temperature by a lower heater not shown in the drawings or the processing head is heated at a predetermined temperature by a heating unit not shown in the drawings.

The optical waveguide sheet, for example, in the case where it is made of the thermoplastic resin, is softened by applying heat. Otherwise, in the case where it is made of the thermosetting resin, it is cured by applying heat so as to maintain the processed shape. In the both cases, the applying temperature is less than the thermal decomposition temperature of the optical waveguide sheet substance.

The processing apparatus used with the above processing head can be achieved by diverting a bonding wire apparatus, namely, by replacing a head of the bonding wire apparatus to the processing head according to the present embodiment.

In the case where the mirror plane is formed in the optical waveguide sheet by using the processing apparatus, by setting or inputting a coordinate of a point to be processed by the processing head in advance, the mirror plane can be formed at any part on high speed, whether or not a position or direction on the optical waveguide is. A processing rate in the above case is approximately the same as a bonding rate for a wire bonding, the processing in five to ten points per second is possible.

The optical waveguide sheet 30 processed as described above is peeled at a boundary surface with the release layer 51, is mounted on a mounting board, and is arranged and used such that a light emitting or receiving portion of a light emitting device or a light receiving device is overlapped with the mirror plane which is the wall surface of the V-shaped groove 30v, corresponding to the end portion of the optical waveguide.

By using the processing head for forming the mirror plane of the optical waveguide sheet, the processing apparatus provided with the same, and the method of forming the mirror plane according to the present embodiment, it is unnecessary to use a special mask and to perform a lithography process, and the mirror plane can be formed simply and accuracy, while a production cost is suppressed. And it is possible to maintain easily a flexibility of a design capable of managing a change of a design and to manage a production for a small amount and numerous varieties of the products.

### Second Embodiment

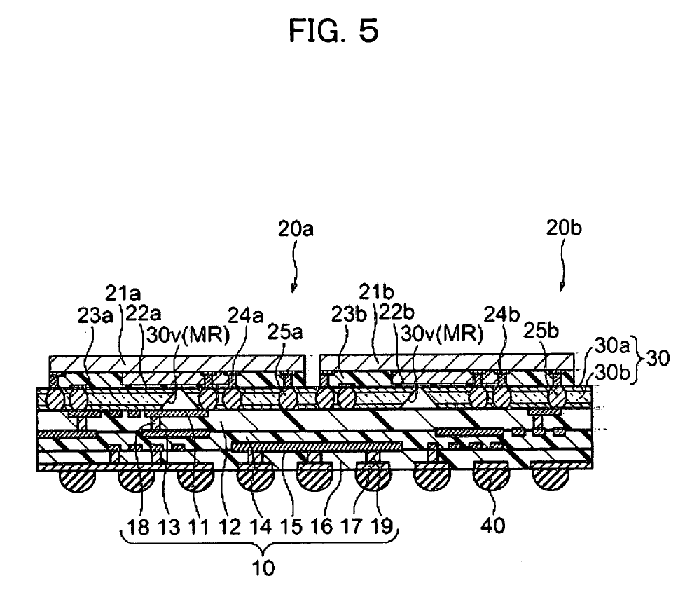

FIG. 5 is a cross-sectional view of an optoelectric device being a multi-chip module according to the present embodiment.

The optical waveguide sheet 30 is bonded to a surface of the mounting board 10 by a bonding layer not shown in the drawings. Via the optical waveguide sheet 30, a semiconductor device 20a into which a light emitting device is built, and a semiconductor device 20b into which a light receiving device is built, are mounted on the mounting board 10. Bumps 40 for mounting the board 10 on other board are formed in the other surface of the mounting board 10.

The mounting board 10 is, for example, formed from four interconnection layers (11, 13, 15, 17) processed in patterns, resin insulation layers (12, 14, 16) stacked and provided therebetween, and vertical interconnections (18, 19) connecting the interconnection layers (11, 13, 15, 17) vertically.

The drawing illustrates a configuration having four interconnection layers and three resin insulation layers, however, other configuration can be used.

The optical waveguide sheet 30 has the cladding 30a having the first refractive index and the cores 30b having a stripe-shaped pattern extending in the light guiding direction in the cladding 30a and having the second refractive index higher than the first refractive index, is formed in a sheet shape, and is formed with the V-shaped groove 30v at a position to be the end portion of the optical waveguide. The wall surface of the V-shaped groove 30v is the mirror plane of the optical waveguide.

The semiconductor device 20a into which the light emitting device is built is formed so that a light emitting device 22a such as VCSEL is mounted on a semiconductor chip 21a formed with a predetermined electric circuit and is sealed by a resin layer 23a, formed with bumps 25a at posts 24a formed so as to penetrate the resin layer 23a and to connect pads of the semiconductor chip 21a, and mounted on the mounting board 10 via the bumps 25a so that a position of a light emitting portion of the light emitting device 22a is overlapped with the mirror plane of the V-shaped groove 30v of the optical waveguide sheet 30.

The semiconductor device 20b into which the light receiving device is built is formed so that a light receiving device 22b such as PIN-PD is mounted on a semiconductor chip 21b formed with a predetermined electric circuit and is sealed by a resin layer 23b, formed with bumps 25b at posts 24b formed so as to penetrate the resin layer 23b and to connect pads of the semiconductor chip 21b, and mounted on a mounting board 10 via the bumps 25b so that a position of a light emitting portion of the light emitting device 22b is overlapped with the mirror plane of the V-shaped groove 30v of the optical waveguide sheet 30.

A light emitted from the light emitting portion of the light emitting device 22a is reflected at the one mirror plane of the V-shaped groove 30v of the end portion of the optical waveguide formed in the optical waveguide sheet to bend a propagating direction at an angle of 90°, and propagated in the optical waveguide. When reaching the V-shaped groove 30v of the other end portion of the optical waveguide, the light is reflected again at the other mirror plane of the wall surface of the groove to bend the direction at the angle of 90°, propagated in an outer direction of the plane of the optical waveguide sheet, and received by the light receiving portion of the light receiving device 22b.

In this way, the semiconductor device having the light emitting device and the semiconductor device having the light receiving device are connected by the optical interconnection.

The optical waveguide sheet 30 is transparent to a light wavelength to be used, for example, it is made of an organic-based substance such as polyimide resin, polyolefin resin, polynorbornene resin, acrylic resin, epoxy resin, or fluoride thereof.

The semiconductor devices (20a, 20b) are mounted on the mounting board 10 by the bumps (25a, 25b) so as to bridge the optical waveguide sheet 30. Otherwise, they may be connected by the bumps (25a, 25b) in pad opening portions penetrating the optical waveguide sheet 30 formed in regions where the light is not guided.

For example, in the case where the light emitted from the light emitting device 22a is a clock signal, an amplifier is provided on the semiconductor chip 21b in the vicinity of the light receiving device 22b, and demodulates the light clock signal received at the light receiving device 22b to an electric clock signal.

In the case where the optical interconnection transfers the clock signal, the light functioning as the clock signal is divided into a plurality of the clock signals in the optical waveguide sheet, so the plurality of the clock signals are received by the light receiving devices. In the above case, distances for guiding the lights from positions placed with the light emitting portion of the light emitting device to positions placed with the light receiving portions of the light receiving devices, may be preferably the same respectively in any path.

In this way, the optical interconnections supplying the clock signal are completely equal length interconnections, so the skew generated in dividing the clock signal into a plurality of the light receiving portions can be almost suppressed.

Next, a method of producing an optoelectric apparatus according to the present embodiment will be described.

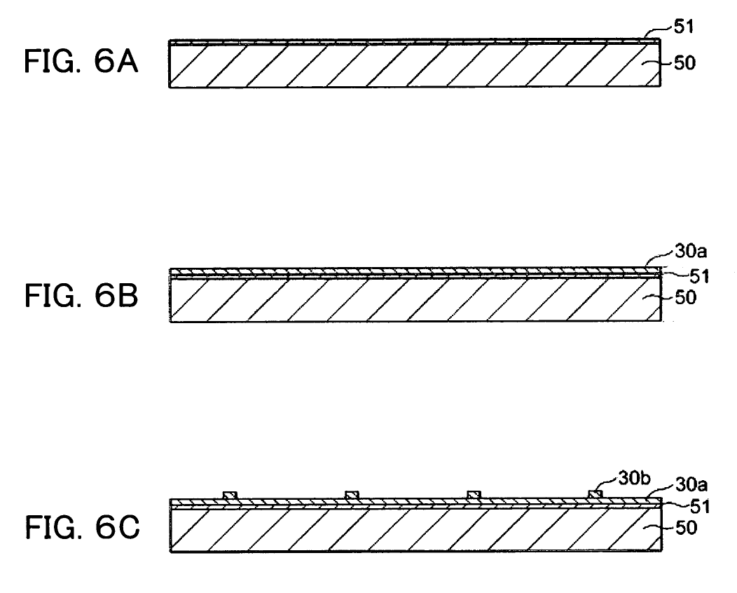

As a method of forming the optical waveguide sheet, first, as shown in FIG. 6A, on a surface of the dummy substrate 50 made of silicon or glass, for example, a stacked body of a titan layer and a copper layer is formed by electron beam deposition method or spattering method to form the release layer 51. Otherwise, a silicon oxide layer may be formed by chemical vapor deposition (CVD) method or spattering method to form the release layer 51. In this case, the dummy substrate 50 is made of silicon.

As shown in FIG. 6B, a resin layer having the first reflective index and made of polyimide resin is formed, for example, by spin coating or printing method, and is cured by performing a cure treatment to form a first cladding 30a.

As shown in FIG. 6C, a photosensitive resin layer having the second reflective index higher than the first reflective index and made of, for example, photosensitive polyimide is formed, exposed by using a patterning mask, and developed and cured to form the core 30b.

For example, assuming the propagation of the multimode, preferably, the thickness and the width of the core 30b are approximately 5 to 50 μm and the thickness of the cladding 30a is approximately ¼ to ½ of the core 30b.

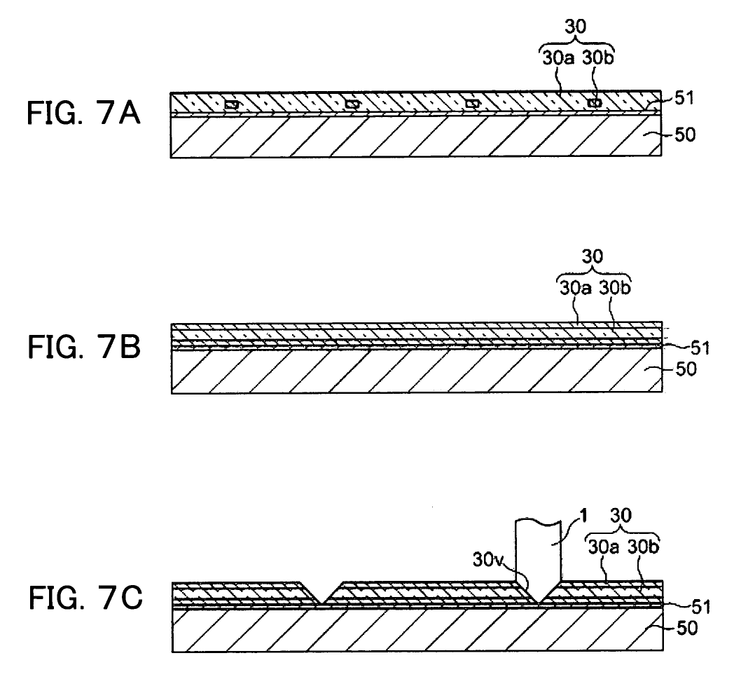

As shown in FIG. 7A, in the same way as the above, the resin layer having the first reflective index and made of polyimide is formed by spin coating or printing method, is reflowed by heating reflow treatment if necessary, and is cured by performing a cure treatment to form the first cladding 30a.

In this way, the optical waveguide sheet in which the core 30b is covered with its surrounding by the cladding 30a, is formed in a sheet shape.

FIG. 7B shows a section parallel to an extending direction of the core in a state of FIG. 7A, and it is the section perpendicular to that of FIG. 7A. The following steps will be described based on the section in this direction.

As shown in FIG. 7C, the processing head described in the first embodiment is positioned at a position to be the end portion of the optical waveguide in the optical waveguide sheet, and is driven by applying a predetermined power. In this case, the processing head is driven up to, for example, reaching the release layer 51 which is the lower layer of the optical waveguide sheet such that the tip portion of the processing head 1 reaches at least a lower surface of the core 30b.

The processing head 1 is released from the optical waveguide sheet 30, so the shape of the first plane la and the second plane 1b of the processing head 1 is transferred to the end portion of the optical waveguide to thereby form the V-shaped groove 30v. The wall surface of the V-shaped groove 30v becomes the mirror plane MR.

In a step of forming the V-shaped groove 30v, since a part of a material of the optical waveguide sheet is push out, the processing residue (burr) 30c may be generated from a portion processed by the processing head 1. Therefore, if necessary, for example, the surface of the optical waveguide is directed facedown on a polishing sheet and the lapping treatment is performed on the surface to remove the processed residue 30c.

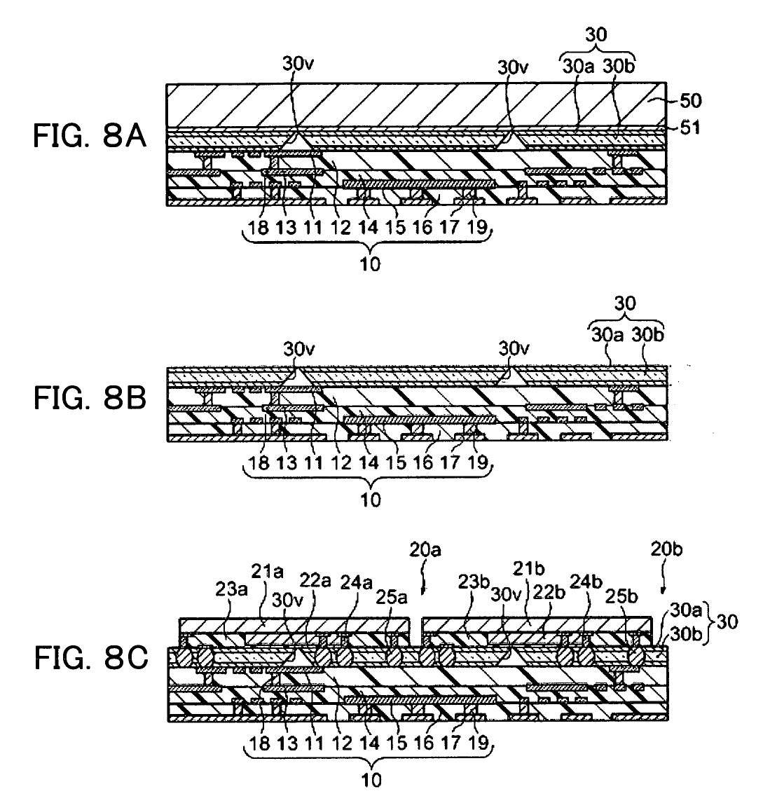

As shown in FIG. 8A, the optical waveguide sheet 30 is laminated to a surface of the mounting board 10 formed by other process in advance by a bonding layer not shown in the drawing.

As shown in FIG. 8B, for example, in the case where the stacked body of the titan layer and the copper layer is used as the release layer 51, it is dipped into acid solution such as hydrochloric acid to separate the release layer 51 side and the optical waveguide sheet 30 side at a boundary surface of the layer 51 and cladding 30a.

Otherwise, in the case where the silicon oxide layer is used as the release layer 51, it is dipped into acid solution such as buffered hydrofluoric acid to dissolve the release layer 51 to thereby separate the optical waveguide sheet 30.

As shown in FIG. 8C, the semiconductor device 20a formed by other process in advance is mounted via the optical waveguide sheet 30 on the mounting board 10 by a bump bonding, such that the light emitting portion of the light emitting device 22a is overlapped with the mirror plane MR of the V-shaped groove 30v of the optical waveguide sheet 30 at the light entering side. The semiconductor device 20b formed by other process in advance is mounted via the optical waveguide sheet 30 on the mounting board 10 by a bump bonding, such that the light receiving portion of the light receiving device 22b is overlapped with the mirror plane MR of the V-shaped groove 30v of the optical waveguide sheet 30 at the light emitting side.

The semiconductor devices (20a, 20b) may be mounted on the mounting board 10 such that the bumps (25a, 25b) bridge the optical waveguide sheet 30, otherwise, pad opening portions penetrating the optical waveguide sheet 30, formed in the region where light is not guided, are provided and the semiconductor devices are connected to the mounting board 10 by the bumps (25a, 25b) in these opening portions.

In the case of providing the above opening portions, for example, lands are formed on the mounting board 10 in advance, and a laser beam such as a CO₂ laser or an excimer laser is irradiated after laminating the optical waveguide sheet to thereby make openings in the optical waveguide sheet 30. In the above case, the land functions as a stopper of the laser beam.

If necessary, bumps 40 for mounting on other mounting board are formed on the other surface of the mounting board 10.

As a result, the optoelectric device (multi-chip module) having the configuration shown in FIG. 5 is produced.

In the method of forming the mirror plane of the optical waveguide sheet used in the present embodiment, it is unnecessary to use a special mask and to perform lithograph process, so the mirror plane of the optical waveguide sheet can be formed simply and accuracy, further a production cost can be suppressed. And it is possible to maintain easily a flexibility of a design capable of managing a change of design and to manage a production for a small amount of and numerous varieties of products.

### Third Embodiment

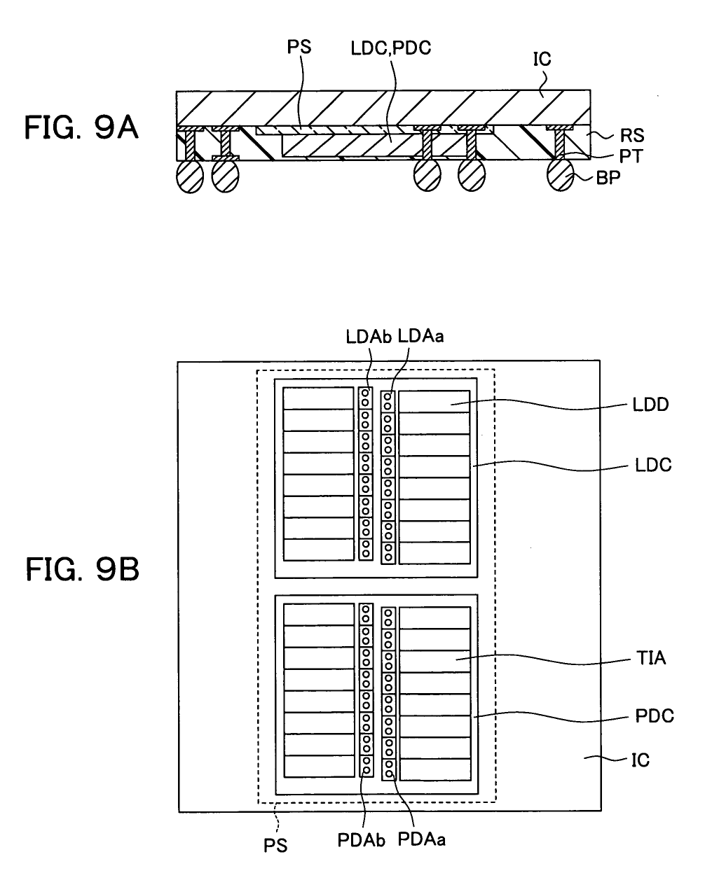

FIG. 9A is a cross-sectional view of an optoelectric device functioning as the multi-chip module according to the present embodiment. FIG. 9B is a plan view thereof.

On a semiconductor chip IC, an optical waveguide sheet PS is laminated by a bonding layer not shown in the drawing and a laser diode chip LDC into which VCSELs are built and a photo diode chip PDC into which PIN-PDs are built are mounted via the optical waveguide sheet PS. The laser diode chip LDC and the photo diode chip PDC are sealed by a resin layer RS. Bumps BP for external connection are formed on posts PT respectively penetrating the resin layer RS and connected to pads of the semiconductor chip IC.

In the laser diode chip LDC, two-row array (LDAa, LDAb) of VCSELs are arranged and provided, and, corresponding to them, laser diode drivers LDD are provided respectively.

Two-row arrays (LDAa, LDAb) of VCSELs are an array in which laser diodes of 16 are arranged in 100 μm pitch, for example, and each row is respectively shifted at 50 μm in an extending direction in parallel. As a result, the two-row arrays are arranged in a staggered arrangement in which 32 of photo diodes are arranged in 50 μm pitch substantially.

The optical waveguide sheet PS has the cladding 30a having the first reflective index, and in the cladding 30a the core 30b having the second reflective index higher than the first reflective index in an extending pattern, so that light emitting portions of 32 of VCSELs in the staggered arrangement of arrays (LDAa, LDAb) of VCSELs and light receiving portions of 32 of PIN-PDs in the staggered arrangement of arrays (PDAa, PDAb) of PIN-PDs are connected, and is formed in a sheet shape, and also is formed with the same V-shaped groove as the optical waveguide sheet of the first and the second embodiments. The wall surface of the V-shaped groove is the mirror plane of the optical waveguide.

The lights, emitted from the respective VCSELs of the laser diode arrays, are reflected at the mirror planes of the V-shaped grooves provided in the optical waveguide sheet, at positions overlapped with VCSELs, to bend the propagating direction of 90°, and are propagated in the optical waveguide. The lights are reflected again at the mirror planes of the V-shaped grooves formed in the optical waveguide sheet, at positions overlapped to PIN-PDs, to bend the direction of 90° again, are emitted in an outer direction of the plane of the optical waveguide sheet, and are received by the respective PIN-PDs of the photodiode arrays.

On a pair of LSIs (LDC, PDC), the light emitting devices such as VCSELs and laser drivers, and the light receiving devices such as PIN-PDs and trans impedance amplifiers are integrated.

For producing these ICs, a transistor having large drive ability, namely, having a large gate width, is demanded. On the other hand, a passive device with a relatively large size as an analog circuit, such as an inductance, is demanded to be formed on LSI. So, a width of a circuit block may be demanded in at least 100 μm.

Generally, a number of buses for a high-speed signal between LSIs in the above way is 1,000 to several 1,000, and is preferably formed in an array-shaped once. So, a pitch of the respective channels is preferably formed as small as possible.

In the present embodiment, the light emitting devices and the light receiving devices are arranged in the staggered-array shapes respectively, so it is possible to form an optical input-output circuit in 100 μm pitch and the optical waveguide in 50 μm pitch.

In a method in related art, it is difficult to form the mirror plane at the optical waveguide so as to correspond to the light emitting device and the light receiving device arranged in the staggered-array shaped. By forming the mirror plane by using the processing head as described in the first embodiment and the second embodiment, the mirror plane in the staggered arrangement can be easily formed.

By the present embodiment, the mirror plane of 45° in the optical waveguide can be formed with simply and low cost without lithographic process. Particularly, in the production for a small amount of and numerous varieties of products, the optical waveguide sheet managing various patterns can be formed in a short period.

In a formation of an optical waveguide with high density, demanded on a system, it is possible to form the mirror plane in the staggered-arrangement or to change a guide direction to a respectively different direction of 90° in a two-dimensional plane free from a restriction, so the flexibility of a design is vastly improved.

The present invention is not limited to the above description.

For example, as a light emitting source of the light applied to the optical waveguide sheet, a light emitting diode may be used other than the laser diode such as VCSEL.

The method of forming the mirror plane of the optical waveguide sheet according to the present invention, is applied to a method of forming a configuration for an MPU or an image processing processor in which high-capacity and high-speed signal processing is demanded such as a computer equipment, a computer for game, a network server, a home server, a brain of robot, or super high-speed signal processing LSI of a high-speed cache memory.

The apparatus of forming the mirror plane of the optical waveguide sheet according to the present invention, is applied to a method of forming the above optical waveguide sheet.

It should be understood by those skilled in the art that various modifications, combinations, sub-combinations and alterations may occur depending on design requirements and other factors in so far as they are within scope of the appeared claims or the equivalents thereof.

What is claimed is:

1. A processing head for a formation of a mirror plane of an optical waveguide sheet, provided at a top of a capillary unit, comprising:
a first plane and a second plane crossing a symmetry axis of the processing head at an angle of 45° and crossing perpendicularly each other at a tip portion of the processing head,
wherein the processing head is driven into an optical waveguide sheet in which an optical waveguide having a cladding and a core buried into the cladding is formed in a sheet shape, at a position to be an end portion of the optical waveguide, so a shape of the first plane and the second plane is transferred at the end portion of the optical waveguide to form a mirror plane.

2. A processing head for a formation of a mirror plane of an optical waveguide sheet as set forth in claim 1 further comprising a heating means for heating the processing head.

3. A processing head for a formation of a mirror plane of an optical waveguide sheet as set forth in claim 1, wherein the processing head is formed of ceramics, artificial mineral, metal, metal alloy, or super steel metal or alloy thereof.

4. A processing apparatus for forming a mirror plane of an optical waveguide sheet having a processing head provided at a top of a capillary unit:
wherein a tip portion of the processing head has a first plane and a second plane crossing a symmetry axis of the processing head and crossing perpendicularly each other at an angle of 45°, and
the processing head is driven into an optical waveguide sheet in which an optical waveguide having a cladding and a core buried into the cladding is formed in a sheet shape, at a position to be an end portion of the optical waveguide, so a shape of the first plane and the second plane is transferred at the end portion of the optical waveguide to form a mirror plane.

5. A processing apparatus for forming a mirror plane of an optical waveguide sheet as set forth in claim 4 further comprising a heating means for heating the processing head.

6. A processing apparatus for forming a mirror plane of an optical waveguide sheet as set forth in claim 4, wherein the processing head is formed of ceramics, artificial mineral, metal, metal alloy, or super steel metal or alloy thereof.

7. A method of forming a mirror plane of an optical waveguide sheet comprising the steps of:
driving a processing head provided at a top of a capillary unit and having a first plane and a second plane crossing a symmetry axis of the processing head at an angle of 45° and crossing perpendicularly each other at a tip portion of the processing head, into an optical waveguide sheet in which an optical waveguide having a cladding and a core buried into the cladding is formed in a sheet shape, at a position to be an end portion of the optical waveguide, and
releasing the processing head from the optical waveguide sheet, and transferring a shape of the first plane and the second plane at the end portion of the optical waveguide to form a mirror plane.

8. A method of forming a mirror plane of an optical waveguide sheet as set forth in claim 7 further comprising a step of removing a processed residue generated by the processing head being driven into the optical waveguide sheet after a step of releasing the processing head.

9. A method of forming a mirror plane of an optical waveguide sheet as set forth in claim 7, wherein, in the step of driving the processing head into the optical waveguide sheet, the processing head is heated.

10. A method of forming a mirror plane of an optical waveguide sheet as set forth in claim 7, wherein the optical waveguide sheet is made of thermoplastic resin.

11. A method of forming a mirror plane of an optical waveguide sheet as set forth in claim 7, wherein the optical waveguide sheet is made of thermosetting resin.

12. A method of forming a mirror plane of an optical waveguide sheet as set forth in claim 7, wherein the processing head is formed of ceramics, artificial mineral, metal, metal alloy, or super steel metal or alloy thereof.
